(19) United States
(12) Patent Application Publication
(10) Pub. No.: US 2024/0352949 A1
(43) Pub. Date: Oct. 24, 2024

(54) CEILING FAN BLADE DEVICE FOR CAPTURING AIRBORNE PARTICLES

(71) Applicant: Adrian Guerrero, Downey, CA (US)

(72) Inventor: Adrian Guerrero, Downey, CA (US)

(21) Appl. No.: 18/138,098

(22) Filed: Apr. 23, 2023

(51) Int. Cl. F04D 29/70; B01D 39/16; B01D 46/00; B01D 53/06; F04D 19/00

(52) U.S. Cl. CPC F04D 29/703; B01D 39/1623; B01D 46/0036; B01D 53/06; F04D 19/002; B01D 2239/0407; B01D 2253/102; B01D 2257/708; B01D 2257/90

(57) ABSTRACT

A system for purifying air is provided comprising a ceiling fan with a plurality of blades and a prism shaped box positioned in a lengthwise manner atop an upper surface of a first blade of the plurality. A leading panel of the box opens when the first blade begins to move. The system also allows airborne particles to enter the box and traps the particles inside the box. The leading panel is located on a forward-facing panel of the prism shaped box. The leading panel opens based on air resistance met based on motion of the first blade. The box contains porous filtering material. The box traps the particles via at least the filtering material. The box is made of cardboard and remains flat with the leading panel in collapsed state when the fan is not turning. An upper surface of the box raises when the fan begins to turn.

### CROSS REFERENCE TO RELATED APPLICATIONS

None

### FIELD OF THE INVENTION

The present disclosure is in the field of air purification. More particularly, the present disclosure provides systems and methods of a box positioned on a ceiling fan blade that opens when the fan is turning to capture airborne particles and trap the particles in filtering inside the box.

### BACKGROUND

An air purifier or air cleaner is a device which removes contaminants from the air in a room to improve indoor air quality. These devices are commonly marketed as being beneficial to allergy sufferers and asthmatics, and at reducing or eliminating second-hand tobacco smoke.

Commercially graded air purifiers are manufactured as either small stand-alone units or larger units that can be affixed to an air handler unit or to a heating, ventilation, and air conditioning (HVAC) unit found in medical, industrial, and commercial buildings. Air purifiers may also be used in industrial applications to remove impurities from air before processing.

Conventional air purifiers consume living space and electricity. They present a tripping hazard and fire risk because of electric cords. Conventional purifiers have motors that pull in contaminated air and blow out filtered air. They are typically louder than expected leading to poor quality sleep and general disruption of quality of life.

### BRIEF DESCRIPTION OF THE FIGURES

FIG. 1 is an image of a system of a ceiling fan blade device for capturing airborne particles according to an embodiment of the present disclosure.

FIG. 2 is an image of a system of a ceiling fan blade device for capturing airborne particles according to an embodiment of the present disclosure.

FIG. 3 is an image of a system of a ceiling fan blade device for capturing airborne particles according to an embodiment of the present disclosure.

### DETAILED DESCRIPTION

Systems and methods described herein provide a prism-shaped air filtration device that is attached atop a ceiling fan blade. A single long front leading edge of the device opens when the fan begins to rotate such that dust, volatile organic compounds, and other airborne particles are captured by the device. The other long edge is permanently closed A filtering pocket opens when the ceiling fan is moving and closes when the fan is off. The device may be attached to the ceiling fan blade via adhesive, including double-sided tape.

The device adheres atop a ceiling fan blade and lies flat and in closed position when the ceiling fan is not being used. The device has an opening at its front or leading edge that faces the direction in which the fan turns. Switching on the ceiling fan results in air contacted by the fan to force the device to open. Air is forced into the filtering pocket accessible via the open edge. Airborne particles are captured on porous filtering material inside the device.

Once a ceiling fan is turned on, air is forced into the filtering pocket opening the filtering chamber so air particles can be captured on porous filtering material. The outer structure which holds the filter may be constructed from a cardstock material that has at least one crease to open similar to a book. The filtering material has an activated carbon filter attached to it to remove odors and volatile organic compounds (VOC) from the air. Filtering material is encapsulated inside outer casing. The outer casing has creases in specific locations that hold filtering material in place.

The outer structure holding the filtering material may be constructed from a paper like cardstock material. The outer structure's cutout configuration can be made by tools including manual die cutter, die cutting and crease press machine, gerber table, rotary die cuter machine, and flexo machine. The prism-shaped device has at least one crease configured to fold open in a manner like a book. The filtering material has an activated carbon filter attached or sewn on to it to remove odors and volatile organic compounds from the air. Other components of the device include filtering fabric that may comprise polypropylene, acrylic fibers, and activated carbon filtering material.

The outer casing of the system may be made from single piece of recycled cardstock paper. It is creased in certain pre-designated areas so it can be folded flat when not in use but raises to its prism-like shape once the fan blade begins to mover. The bottom of the device which sits on top of the ceiling fan has an adhesive which may be on two thirds of the surface, easing removal of the used filter.

Unlike traditional air purifiers, the system does not require an additional source of energy to operate. The system uses passive energy from the ceiling fan, making a ceiling fan sufficient to meet a user's needs.

Conventional air purifiers have built in settings to reduce or increase the speed in which the motor sucks in contaminated air. Because the design of the present system has no electronic components, the speed in which air passes through the filter can be adjusted by simply pulling the speed settling chains on the ceiling fan.

Ceiling fans naturally bring airborne contaminants towards the top of a ceiling fan which leads to a buildup of dust on the forward thin surface of the fan blades. The present system captures a portion of that dust before it has the chance to settle onto fan blades, so less fan blade maintenance is required. A user may spend less time climbing atop a chair or ladder with a vacuum cleaner in hand to vacuum dust from the upper surfaces of fan blades. Risk of injury from falls may also be reduced.

Materials used include cardstock casing with print (paper) and Merv 13 filtering fabric (polypropylene and acrylic fibers). Materials also include activated carbon filter made of raw materials such as coal, wood, coconut husk, and bamboo. Materials further include clear gel double sided tape with butyl adhesive.

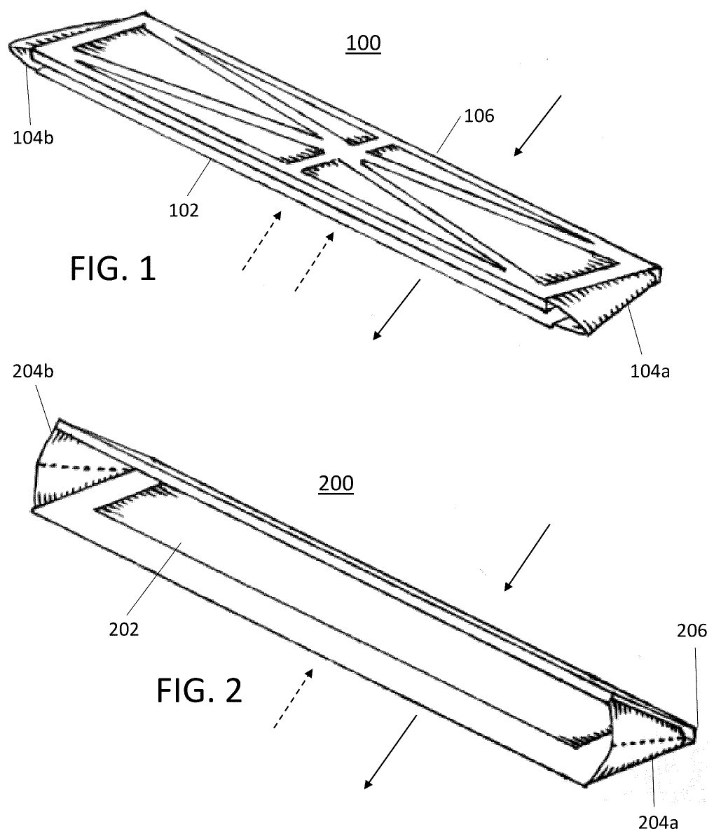

Turning to the figures, FIG. 1 is an image of a system of a ceiling fan blade device for capturing airborne particles according to an embodiment of the present disclosure. FIG. 1 depicts the device 100 in flattened or closed state. This is the state of the device 100 when the ceiling fan is not activated and the fan blade upon which the device 100 is attached is not moving. FIG. 1 also depicts a front edge panel 102 that is flat and effectively non-existent when the fan is not moving. The solid arrows in FIG. 1 indicate the direction in which the device 100 and the fan blade move. The dashed arrows in FIG. 1 indicate the direction in which air rushes into the device 100 through the front edge panel 102 that opens as the device 100 moves faster and faster after the fan is turned on.

Side panels 104a-b are shown in their inactive or slack state in FIG. 1 because the device 100 in FIG. 1 is not open and is flattened. Spine 106 is similar to a binding or spine of a book that does not have components that move and remains stationary whether the device 100 is closed as in FIG. 1 or partially or fully open when the ceiling fan blade is turning.

Components illustrated in FIG. 2 are fully indexed to components illustrated in FIG. 1. FIG. 2 is a diagram of the device 200 in fully open state as air, represented by dashed arrows, is forced into the device 200 through the front edge panel 202 which in FIG. 2 is fully open. Of note in FIG. 2 are the side panels 204a-b which are shown in fully stretched, open, and extended state because the device 200 is fully open. The spine 206 remains rigid and anchored to the surface of the ceiling fan blade.

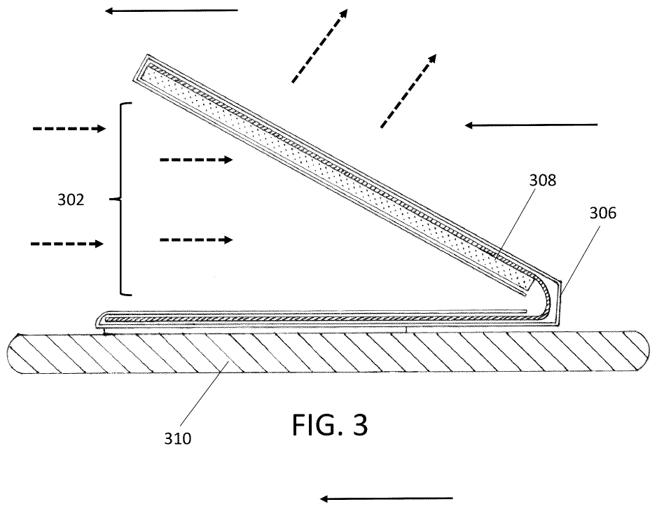

Components illustrated in FIG. 3 are indexed to components illustrated in FIG. 1 and FIG. 2. A side view of the device 300 is provided in FIG. 3. Side panels are not shown to facilitate illustration and discussion. Newly depicted components in FIG. 3 comprise a fan blade 310 and filtering material 308. The front edge panel 302 is shown with an open left-hand bracket to illustrate that the front edge panel 302 is an open space when the device 300 is open. Again, movement of air is shown with dashed arrows and movement of the device is shown with solid arrows.

The device 300 may in its shape resemble a dust jacket or cover of a hardcover book. As with a dust jacket, the end flaps come up over and down the inside surfaces of the device 300. It is provided in this shape and functionality to hold the filtering material 308 firm inside the device 300 as the filtering material 308 in some embodiments is not physically attached to the device 300 and is instead firmly positioned inside the device 300. This structure allows the filtering material 308 to be easily removed.

Previous implementations have provided various systems and methods that are surpassed in functionality by systems and methods provided herein. Most such previous implementations involve a single static structure with no moving parts positioned on a ceiling fan whereon airborne objects and particles stick or adhere as the fan turns and contact is made. But those previous embodiments do not trap airborne particles inside a box or other container that contains filtering material within.

In an embodiment, a system for purifying air is provided. The system comprises a ceiling fan with a plurality of blades, a prism shaped box positioned in a lengthwise manner atop an upper surface of a first blade of the plurality, and a leading panel of the box that opens when the first blade begins to move. The system also allows airborne particles to enter the box and traps the particles inside the box.

The leading panel is located on a forward-facing panel of the prism shaped box. The leading panel opens based on air resistance met based on motion of the first blade.

The box contains porous filtering material. The box traps the particles via at least the filtering material. The box is made of cardboard and remains flat with the leading panel in collapsed state when the fan is not turning. An upper surface of the box raises when the fan begins to turn, the raising caused by the opening of the leading panel based on the air resistance and by the box filling with air.

The box has creases and folds that facilitate full formation of the box as the upper surface raises and the box fills with air. The material comprises filtering fabric comprising at least one of polypropylene, acrylic fibers, and activated carbon filtering material.

In another embodiment, a method for capturing airborne particles is provided. The method comprises a prism-shaped box positioned on its side in a flattened state receiving propulsion to begin movement. The method also comprises the box, based on air entering through an open, forward-facing panel, opening. The method also comprises the box, via the open, forward-facing panel, and based on the movement, receiving entry of airborne particles. The method also comprises the box receiving attachment to a flat upper surface of a blade of a ceiling fan on a side of the box adjacent to the open, forward-facing panel. The open, forward-facing panel is forced open by air resistance encountered based on turning of the fan blade. The box traps the particles via at least filtering material located within the box. An upper surface of the box raises when the fan begins to turn, the raising caused by entry of air into the box through the open, forward-facing panel.

In yet another embodiment, a method of clearing airborne particles from a space is provided. The method comprises a flat, creased cardboard structure positioned atop a blade of a ceiling fan receiving motion based on activation of the fan. The method also comprises the structure opening based on air resistance exerted against the structure and based on air entering the structure via an open panel in the structure. The method also comprises the structure, via the slot, capturing airborne particles inside the structure.

The method also comprises the structure taking a form of a prism shaped box positioned on its side upon the structure fully opening. The method also comprises the structure containing filtering material that captures the particles.

The open panel is in a forward-facing portion of the structure. The method also comprises the cardboard structure in flattened state has preconfigured creases and folds. The structure opens into box form along the preconfigured creases as air enters the structure via the open panel.

What is claimed is:

1. A system for purifying air, comprising
a ceiling fan with a plurality of blades;
a prism shaped box positioned in a lengthwise manner atop an upper surface of a first blade of the plurality; and
a leading panel of the box that:
opens when the first blade begins to move,
allows airborne particles to enter the box, and
traps the particles inside the box.

2. The system of claim 1, wherein the leading panel is located on a forward-facing panel of the prism shaped box.

3. The system of claim 1, wherein the leading panel opens based on air resistance met based on motion of the first blade.

4. The system of claim 1, wherein the box contains porous filtering material.

5. The system of claim 4, wherein the box traps the particles via at least the filtering material.

6. The system of claim 1, wherein the box is made of cardboard and remains flat with the leading panel in collapsed state when the fan is not turning.

7. The system of claim 1, wherein an upper surface of the box raises when the fan begins to turn, the raising caused by the opening of the leading panel based on the air resistance and by the box filling with air.

8. The system of claim 7, wherein the box has creases and folds that facilitate full formation of the box as the upper surface raises and the box fills with air.

9. The system of claim 1, wherein the material comprises filtering fabric comprising at least one of polypropylene, acrylic fibers, and activated carbon filtering material.

10. A method for capturing airborne particles, comprising:
a prism-shaped box positioned in a lengthwise manner on its side in a flattened state receiving propulsion to begin movement;
the box, based on air entering through an open, forward-facing panel, opening; and
the box, via the open, forward-facing panel, and based on the movement, receiving entry of airborne particles.

11. The method of claim 10, further comprising the box receiving attachment to a flat upper surface of a blade of a ceiling fan on a side of the box adjacent to the open, forward-facing panel.

12. The method of claim 10, wherein the open, forward-facing panel is forced open by air resistance encountered based on turning of the fan blade.

13. The method of claim 10, wherein the box traps the particles via at least filtering material located within the box.

14. The method of claim 10, wherein an upper surface of the box raises when the fan begins to turn, the raising caused by entry of air into the box through the open, forward-facing panel.

15. A method of clearing airborne particles from a space, comprising:
a flat, creased cardboard structure positioned atop a blade of a ceiling fan receiving motion based on activation of the fan;
the structure opening based on air resistance exerted against the structure and based on air entering the structure via an open panel in the structure; and
the structure, via the slot, capturing airborne particles inside the structure.

16. The method of claim 15, further comprising the structure taking a form of a prism shaped box positioned on its side upon the structure fully opening.

17. The method of claim 15, further comprising the structure containing filtering material that captures the particles.

18. The method of claim 15, wherein the open panel is in a forward-facing portion of the structure.

19. The method of claim 15, wherein the cardboard structure in flattened state has preconfigured creases and folds.

20. The method of claim 19, wherein the structure opens into box form along the preconfigured creases as air enters the structure via the open panel.
